(19) United States
(12) Patent Application Publication
(10) Pub. No.: US 2009/0226674 A1
(43) Pub. Date: Sep. 10, 2009

(54) Phthalocyanine Inks and their Use in Ink-Jet Printing

(75) Inventor: Thomas Paul, Manchester (GB)

Correspondence Address: MORGAN LEWIS & BOCKIUS LLP, 1111 PENNSYLVANIA AVENUE NW, WASHINGTON, DC, 20004, US

(73) Assignee: FUJIFILM IMAGING COLORANTS LIMITED, Manchester (GB)

(21) Appl. No.: 11/992,955

(22) PCT Filed: Sep. 29, 2006
(86) PCT No.: PCT/GB2006/003609

§ 371 Date: Apr. 2, 2008

(30) Foreign Application Priority Data
Oct. 13, 2005 (GB) 0520793.1

(51) Int. Cl. C09D 11/02; B05D 5/00; B32B 3/10; C09B 47/04

(52) U.S. Cl. 428/195.1; 106/31.49; 427/256; 540/140

(57) ABSTRACT

A composition comprising:
a) a major dye component which is the gluconic acid salt of a mixture of phthalocyanine dyes of Formula (1):

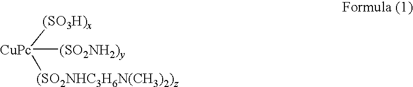

wherein:
Pc represents a phthalocyanine nucleus of formula;

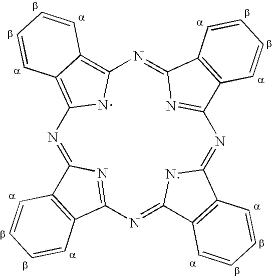

x is 0 to 3.9;
y is 0 to 3.9;
z is 0.1 to 4.0;
the sum of (x+y+z) is 4; and
the substituents, represented by x, y and z are attached to a β position on the phthalocyanine ring; and
(b) a liquid medium. Also ink-jet printing processes, printed materials, ink-jet cartridges and dye salts.

This invention relates to inks, to printing processes, to printed substrates and to ink-jet printer cartridges.

Ink-jet printing is a non-impact printing technique in which droplets of ink are ejected through a fine nozzle onto a substrate without bringing the nozzle into contact with the substrate. The set of inks used in this technique typically comprise yellow, magenta, cyan and black inks.

With the advent of high-resolution digital cameras and ink-jet printers it is becoming increasingly common for consumers to print off photographs using an ink-jet printer. This avoids the expense and inconvenience of conventional silver halide photography and provides a print quickly and conveniently.

While ink-jet printers have many advantages over other forms of printing and image development there are still technical challenges to be addressed. For example, there are the contradictory requirements of providing ink colorants that are soluble in the ink medium and yet do not run or smudge excessively when printed on paper. The inks need to dry quickly to avoid sheets sticking together after they have been printed, but they should not form a crust over the tiny nozzle used in the printer. Storage stability is also important to avoid particle formation that could block the tiny nozzles used in the printer especially since consumers can keep an ink-jet ink cartridge for several months. Furthermore, the resultant images desirably do not fade rapidly on exposure to light or common atmospheric oxidising gases such as ozone.

If ink is to be used in an ink-jet printer it must be able to repeatedly fire through the ink-jet head. To do this it must have a low viscosity. In general an ink will have problems firing through a print head if its viscosity is much more than 6 cp at 25° C.

Most cyan colorants used in ink-jet printing are based on phthalocyanines and problems of fading and shade change on contact with ozone are particularly acute with dyes of this class especially when they are printed onto media containing inorganic particles such as silica and/or alumina. There appears to be some aspect of the environment on the surface of such media (particularly media used for photo-realistic ink-jet printing) that promotes deterioration of these dyes in the presence of ozone.

C.I. Basic Blue 33.1 is a phthalocyanine dye that has been known and used in applications such as leather dying for many years. However its use in ink-jet printing inks has been extremely limited.

Phthalocyanines such as C.I. Basic Blue 33.1 as supplied are a complex mixture. We have surprisingly found that narrow group of compounds within this mixture gives ink-jet inks which display various advantageous properties.

Thus, the present invention provides a composition comprising:

(a) a dye component comprising a major dye component which is the gluconic acid salt of a mixture of phthalocyanine dyes of Formula (1):

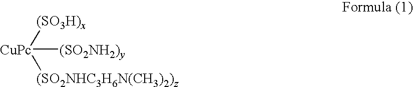

wherein:

Pc represents a phthalocyanine nucleus of formula;

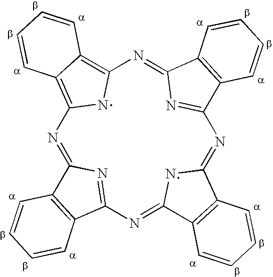

x is 0 to 3.9;

y is 0 to 3.9;

z is 0.1 to 4.0;

the sum of (x+y+z) is 4; and

the substituents, represented by x, y and z are attached to β position on the phthalocyanine ring; and

(b) a liquid medium.

When a dye of Formula (1) is made by the more usual route of sulfonating a phthalocyanine pigment followed by chlorination and then amination/amidation then the resultant product is a complex mixture comprising species with varying levels of substitution and with sulfo and sulfonamide substituents distributed randomly in both the α- and β-positions.

The phthalocyanine dyes of Formula (1) where the substituents are attached to a β-position on the phthalocyanine ring may be prepared by any method known in the art, and particularly by cyclisation of appropriate β-substituted phthalic acid, phthalonitrile, iminoisoindoline, phthalic anhydride, phthalimide or phthalamide in the presence of a suitable nitrogen source (if required), a suitable metal salt such as, for example, CuCl₂, and a base such as 1,8-diazabicyclo[5.4.0]undec-7-ene (DBU).

Preferably copper phthalocyanine dyes of Formula (1) where the sulfo and substituted sulfonamide substituents are attached to a β-position on the phthalocyanine ring are prepared by cyclisation of 4-sulfophthalic acid to phthalocyanine β-tetrasulfonic acid in the presence of a nitrogen source such as urea, a suitable metal salt such as, for example, CuCl₂ and a base such as 1,8-diazabicyclo[5.4.0]undec-7-ene (DBU) to give phthalocyanine β-tetrasulfonic acid, a reaction well known in the art. The phthalocyanine β-tetrasulfonic acid is then chlorinated and the sulfonyl chloride groups so formed are reacted with N,N-dimethylaminopropylamine and optionally ammonia. This reaction is preferably performed in water at a pH above 7. Typically the reaction is performed at a temperature of 30 to 70° C. and is usually complete in less than 24 hours. N,N-Dimethylaminopropylamine and ammonia may be used as a mixture or added sequentially.

The ratio of sulfo to sulfonamide substituents may be varied by varying the nature and amount of chlorinating agent used, the relative amounts of N,N-dimethylaminopropylamine and ammonia used and the reaction conditions employed in both reactions.

When phthalocyanine β-tetrasulfonic acid is an intermediate in a route to compounds of Formula (1) it may be chlorinated by reacting with any suitable chlorinating agent.

Chlorination is preferably carried out by treating the phthalocyanine β-tetrasulfonic acid with chlorosulfonic acid preferably in the presence of an acid halide such as thionyl chloride, sulfuryl chloride, phosphorous pentachloride, phosphorous oxychloride or phosphorous trichloride.

When the preferred route, as set out above, is used to synthesise dyes of Formula (1) then they are predominantly formed as chloride salts. However, any known technique may be used to exchange chloride for gluconic acid example, adjusting the pH of a solution of the chloride salt to an alkali value followed by dialysis, to remove the chloride with the subsequent addition of gluconic acid. Use of ion exchange resins and reverse osmosis membranes are other well-known techniques suitable for this exchange of anions. These different techniques are often combined for optimum efficacy.

In the compounds of the present invention the α-positions of the phthalocyanine ring are preferably unsubstituted, that is they carry a hydrogen substituent.

Preferably x is greater than 0, more preferably greater than 0.1 and especially greater than 0.5.

In one preferred embodiment y is 0.

In another preferred embodiment y is greater than 0, more preferably greater than 0.1 and especially greater than 0.5.

Preferably z is greater than 1, more preferably z is greater than 2.

A preferred compound of Formula (1) is of Formula (2) and salts thereof:

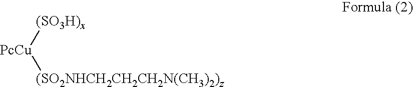

wherein:

Pc represents a phthalocyanine nucleus of formula;

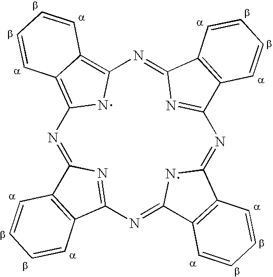

x is 0 to 3.9;

z is 0.1 to 4;

the sum of (x+z) is 4; and

the substituents, represented by x and z are attached to a β position on the phthalocyanine ring.

Preferences for x and z are as outlined above.

The compounds of Formula (1) may exist in tautomeric forms other than those shown in this specification. These tautomers are included within the scope of the present invention.

The liquid medium (b) may comprise water, water and organic solvent or organic solvent free from water. Preferably the liquid medium (b) comprises water and organic solvent or organic solvent free from water.

When the medium (b) comprises a mixture of water and organic solvent, the weight ratio of water to organic solvent is preferably from 99:1 to 1:99, more preferably from 99:1 to 50:50 and especially from 95:5 to 80:20.

It is preferred that the organic solvent present in the mixture of water and organic solvent is a water-miscible organic solvent or a mixture of such solvents. Preferred water-miscible organic solvents include C₁₋₆alkanols, preferably methanol, ethanol, n-propanol, isopropanol, n-butanol, sec-butanol, tert-butanol, n-pentanol, cyclopentanol and cyclohexanol; linear amides, preferably dimethylformamide or dimethylacetamide; ketones and ketone-alcohols, preferably acetone, methyl ether ketone, cyclohexanone and diacetone alcohol; water-miscible ethers, preferably tetrahydrofuran and dioxane; diols, preferably diols having from 2 to 12 carbon atoms, for example pentane-1,5-diol, ethylene glycol, propylene glycol, butylene glycol, pentylene glycol, hexylene glycol and thiodiglycol and oligo- and poly-alkyleneglycols, preferably diethylene glycol, triethylene glycol, polyethylene glycol and polypropylene glycol; triols, preferably glycerol and 1,2,6-hexanetriol; mono-C₁₋₄-alkyl ethers of diols, preferably mono-C₁₋₄-alkyl ethers of diols having 2 to 12 carbon atoms, especially 2-methoxyethanol, 2-(2-methoxyethoxy)ethanol, 2-(2-ethoxyethoxy)-ethanol, 2-[2-(2-methoxyethoxy)ethoxy]ethanol, 2-[2-(2-ethoxyethoxy)-ethoxy]-ethanol and ethyleneglycol monoallylether; cyclic amides, preferably 2-pyrrolidone, N-methyl-2-pyrrolidone, N-ethyl-2-pyrrolidone, caprolactam and 1,3-dimethylimidazolidone; cyclic esters, preferably caprolactone; sulfoxides, preferably dimethyl sulfoxide and sulfolane. Preferably the liquid medium comprises water and 2 or more, especially from 2 to 8, water-miscible organic solvents.

Especially preferred water-miscible organic solvents are cyclic amides, especially 2-pyrrolidone, N-methyl-pyrrolidone and N-ethyl-pyrrolidone; diols, especially 1,5-pentane diol, ethyleneglycol, thiodiglycol, diethyleneglycol and triethyleneglycol; and mono-C₁₋₄-alkyl and C₁₋₄-alkyl ethers of diols, more preferably mono-C₁₋₄-alkyl ethers of diols having 2 to 12 carbon atoms, especially 2-methoxy-2-ethoxy-2-ethoxyethanol.

Examples of further suitable liquid media comprising a mixture of water and one or more organic solvents are described in U.S. Pat. No. 4,963,189, U.S. Pat. No. 4,703,113, U.S. Pat. No. 4,626,284 and EP 4,251,50A.

When the liquid medium comprises water or water and organic solvent then preferably the pH is in the range pH7 to 10.

When the liquid medium comprises organic solvent free from water, (i.e. less than 1% water by weight) the solvent preferably has a boiling point of from 30° to 200° C., more preferably of from 40° to 150° C., especially from 50° to 125° C. The organic solvent may be water-immiscible, water-miscible or a mixture of such solvents. Preferred water-miscible organic solvents are any of the hereinbefore-described water-miscible organic solvents and mixtures thereof. Preferred water-immiscible solvents include, for example, aliphatic hydrocarbons; esters, preferably ethyl acetate; chlorinated hydrocarbons, preferably CH₂Cl₂; and ethers, preferably diethyl ether; and mixtures thereof.

When the liquid medium comprises a water-immiscible organic solvent then preferably a polar solvent is preferably included since this enhances solubility of the compound of Formula (1) in the liquid medium. Examples of polar solvents include C₁₋₄-alcohols.

It is especially preferred that where the liquid medium is organic solvent free from water it comprises a ketone (especially methyl ethyl ketone) and/or an alcohol (especially a C₁₋₄-alkanol, more especially ethanol or propanol).

The organic solvent free from water may be a single organic solvent or a mixture of two or more organic solvents. It is preferred that when the medium is organic solvent free from water it is a mixture of 2 to 5 different organic solvents. This allows a medium to be selected that gives good control over the drying characteristics and storage stability of the ink.

Liquid media comprising organic solvent free from water are particularly useful where fast drying times are required and particularly when printing onto hydrophobic and non-absorbent substrates, for example plastics, metal and glass.

The liquid media may of course contain additional components conventionally used in ink-jet printing inks, for example viscosity and surface tension modifiers, corrosion inhibitors, biocides, kogation reducing additives and surfactants which may be ionic or non-ionic.

Although not usually necessary, further colorants may be added to the composition to modify the shade and performance properties. Examples of such colorants include C.I. Direct Yellow 86, 132, 142 and 173; C.I. Direct Blue 307; C.I. Food Black 2; C.I. Direct Black 168 and 195; C.I. Acid Yellow 23.

The term major dye component may be taken to indicate that the dye of Formula (1) is added to the ink so as to have a discrete colour effect. Thus, if the composition of the present invention is black ink and a cyan dye of Formula (1) is added to this ink for the purpose of shading then the cyan dye of Formula (1) would still be considered to be a major dye component.

If the composition of the present invention contains phthalocyanine dyes other than those of Formula (1) then preferably at least 50% by weight, more preferably 70% by weight, especially 80% by weight, more especially 90% by weight, particularly 95% by weight and more particularly 99% by weight of the total amount of phthalocyanine dye is of Formula (1) wherein the substituents, represented by x, y and z, are attached to a β position on the phthalocyanine ring.

Preferably the only phthalocyanine dye present in the compositions of the present invention is of Formula (1) wherein the substituents, represented by x, y and z, are attached to a β position on the phthalocyanine ring.

It is preferred that the composition according to the invention is ink suitable for use in an ink-jet printer. Ink suitable for use in an ink-jet printer is ink which is able to repeatedly fire through an ink-jet printing head without causing blockage of the fine nozzles.

Ink suitable for use in an ink-jet printer preferably has a viscosity of less than less than 6 cP, at 25° C.

Ink suitable for use in an ink-jet printer preferably contains less than 500 ppm, more preferably less than 250 ppm, especially less than 100 ppm, more especially less than 10 ppm in total of divalent and trivalent metal ions (other than any divalent and trivalent metal ions bound to a colorant of Formula (1) or any other component of the ink).

Preferably ink suitable for use in an ink-jet printer has been filtered through a filter having a mean pore size below 10 μm, more preferably below 3 μm, especially below 2 μm, more especially below 1 μm. This filtration removes particulate matter that could otherwise block the fine nozzles found in many ink-jet printers.

Preferably ink suitable for use in an ink-jet printer contains less than 500 ppm, more preferably less than 250 ppm, especially less than 100 ppm, more especially less than 10 ppm in total of halide ions.

Preferred compositions comprise:

(a) from 0.01 to 30 parts of compounds of Formula (1); and

(b) from 70 to 99.99 parts of a liquid medium;

wherein all parts are by weight.

Preferably the number of parts of (a)+(b)=100.

The number of parts of component (a) is preferably from 0.1 to 20, more preferably from 0.5 to 15, and especially from 1 to 5 parts. The number of parts of component (b) is preferably from 80 to 99.9, more preferably from 85 to 99.5 and especially from 95 to 99 parts.

Preferably component (a) is completely dissolved in component (b). Preferably component (a) has a solubility in component (b) at 20° C. of at least 10%. This allows the preparation of liquid dye concentrates that may be used to prepare more dilute inks and reduces the chance of the dye precipitating if evaporation of the liquid medium occurs during storage.

The inks may be incorporated in an ink-jet printer as high concentration cyan ink, low concentration cyan ink or both high concentration and low concentration ink. In the latter case this can lead to improvements in the resolution and quality of printed images. Thus the present invention also provides a composition where component (a) is present in an amount of 2.5 to 7 parts, more preferably 2.5 to 5 parts (high concentration ink) or component (a) is present in an amount of 0.5 to 2.4 parts, more preferably 0.5 to 1.5 parts (low concentration ink).

Compositions according to the present invention yield prints that display a good fastness to water, ozone and light. In particular, prints prepared using these inks display excellent light and ozone fastness.

A second aspect of the invention provides a process for forming an image on a substrate comprising applying ink suitable for use in an ink-jet printer, according to the first aspect of the invention, thereto by means of an ink-jet printer.

The ink-jet printer preferably applies the ink to the substrate in the form of droplets that are ejected through a small orifice onto the substrate. Preferred ink-jet printers are piezoelectric ink-jet printers and thermal ink-jet printers. In thermal ink-jet printers, programmed pulses of heat are applied to the ink in a reservoir by means of a resistor adjacent to the orifice, thereby causing the ink to be ejected from the orifice in the form of small droplets directed towards the substrate during relative movement between the substrate and the orifice. In piezoelectric ink-jet printers the oscillation of a small crystal causes ejection of the ink from the orifice. Alternately the ink can be ejected by an electromechanical actuator connected to a moveable paddle or plunger, for example as described in International Patent Application WO00/48938 and International Patent Application WO00/55089.

The substrate is preferably paper, plastic, a textile, metal or glass, more preferably paper, an overhead projector slide or a textile material, especially paper.

Preferred papers are plain or treated papers which may have an acid, alkaline or neutral character. Glossy papers are especially preferred.

Photographic quality paper is particularly preferred.

A third aspect of the present invention provides a material preferably paper, plastic, a textile, metal or glass, more preferably paper, an overhead projector slide or a textile material, especially paper more especially plain, coated or treated papers printed with a composition according to the first aspect of the invention or by means of a process according to the second aspect of the invention.

It is especially preferred that the printed material of the third aspect of the invention is a photographic reproduction.

A fourth aspect of the present invention provides an ink-jet printer cartridge comprising a chamber and an ink wherein the ink is in the chamber and the ink is as defined in the first aspect of the present invention. The cartridge may contain a high concentration ink and a low concentration ink, as described in the first aspect of the invention, in different chambers.

A fifth aspect of the invention provides a gluconic acid salt of a compound of Formula (1)

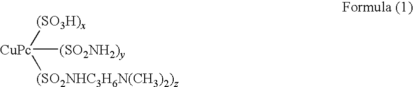

wherein:

Pc represents a phthalocyanine nucleus of formula;

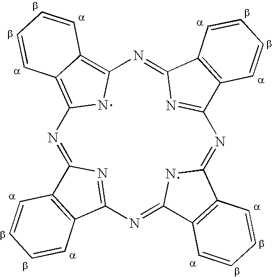

x is 0 to 3.9;

y is 0 to 3.9;

z is 0.1 to 4.0; and

the sum of (x+y+z) is 4.

Wherein the preferences for x, y and z are as described in the first aspect of the invention.

The invention is further illustrated by the following Examples in which all parts and percentages are by weight unless otherwise stated.

### EXAMPLES

### Analysis of Dyes of Formula (1)

Confirmation of the number of substituents on dyes of Formula (1) is by mass spectrometry. Elemental analysis is used to determine the ratios of x to y+z. Thus, when the sum of x plus y and z is not exactly 4 this is thought to be due to the presence of impurities. The presence of these impurities and their effect on the estimated values of x, y and z would be well known to a person skilled in the art who would treat the experimentally determined values of x, y and z simply as indicative of the presence of these substituents.

### Example 1

The gluconic acid salt of a compound of formula:

CuPc(SO₃H)_{0.8}(SO₂NHCH₂CH₂CH₂N(CH₃)₂)_{3.4}

wherein all the substituents are attached to a E-position of the phthalocyanine ring, was prepared as described below.

### Stage 1

### Preparation of Copper Phthalocyanine Tetra-β-Sulfonate

Potassium 4-sulfophthalic acid (56.8 g), urea (120 g), CuCl₂ (6.9 g), ammonium molybdate (1.2 g) and 1,8-diazabicyclo[5.4.0]undec-7-ene (DBU) (7.5 g) were mixed in a reaction vessel. The mixture was warmed in stages (130° C./30 minutes, 150° C./30 minutes, 180° C./30 minutes, 220° C./30 minutes) over 2 hours and the melt which formed was stirred at 220° C. for a further 2 hours. The resultant solid was extracted 4 times with hot water (4×200 ml) and the extract was filtered to remove insoluble material. The filtrate was stirred at between 60° C.-70° C. and then sufficient NaCl was added to give a 7% salt solution. Stirring was continued and the precipitate was filtered, washed with a 10% salt solution (200 ml) and pulled dry by vacuum. The resultant damp solid (77.6 g) was slurried in acetone, filtered and dried, first at room temperature and then at 50° C.

### Stage 2

### Preparation of the Chloride Salt of the Compound of Example 1

Phosphorous oxychloride (11.92 g) was added dropwise to chlorosulfonic acid (116.5 g) over 5 to 10 minutes while keeping the temperature below 30° C. When all the POCl₃ had been added, the product of stage 1 (22 g) was added portion-wise while keeping the reaction temperature below 60° C., this addition took 20-30 minutes. The reaction mixture was stirred at 50-60° C. for 15-20 minutes. The temperature of the reaction mixture was then gradually increased to 138-140° C. over 30 minutes, held at this temperature for 6.5 hours and then stirred overnight at room temperature. The mixture was added to water/ice/NaCl/concentrated HCl (120 ml/120 g/15 g/8 ml). The solid that precipitated was filtered, washed with ice cold acidified 5% salt solution and pulled dry using a vacuum pump. The resultant damp paste (39 g) in water (100 ml) was added to a mixture of N,N dimethylaminopropylamine (16.32 g) and water (100 ml) at 0°-10° C. Pyridine (5 ml) added and the mixture was stirred at 0° to 10° C. (pH>11) for 0.5 hours. The reaction mixture was then stirred at 40-45° C. for 1.5 hours, at room temperature overnight and, the next day, at 80-85° C. for 2.5 hours. At the end of this time the reaction mixture was salted with NaCl. The solid which precipitated was filtered and then washed with an 20% NaCl solution. The resultant damp solid was dissolved in deionised water, dialysed, filtered and then dried at 70° C. to give 7.7 g of product.

### Stage 3

### Preparation of the Chloride-Free Form of the Title Compound

The product of stage 2 was dissolved as a 3% w/w solution in 6 litres of water and then diluted to 36 litres and the pH adjusted to pH10 with sodium hydroxide. This solution was washed at a constant volume at 30° C. and 10 bar using a ceramic cross flow membrane from Pall (molecular weight cut-off 50,000 Dalton) with a total 18 wash volumes of deionised water and the pH of the dye solution was maintained at pH 10±0.3 using sodium hydroxide. The dye solution was then concentrated by reverse osmosis to yield a 2.18% w/w solution.

### Stage 4

### Preparation of the Title Compound

A chloride-free solution of the product of stage 3 (688 g of a 2.18% (w/w) solution, pH 10.6) was stirred at room temperature and over 30 minutes 9.55 g of an aqueous (45% w/w) solution of gluconic acid was added. After complete addition the mixture was stirred for an additional 1 hour at room temperature. The solution was then dried to yield 19.1 g of the title compound.

### Comparative Example

The Comparative Example was the hydrochloride salt of the compound of Example 1.

### Example 2

### Preparation of the Example Ink and the Comparative Ink

Ink according to the invention and a Comparative Ink were prepared by dissolving 3 g of the dye of Example 1 and 3 g of the dye of the Comparative Example in 97 ml of a liquid medium consisting of 5 parts 2-pyrrolidone; 5 parts thiodiethylene glycol; 1 part Surfynol™ 465 and 89 parts water and adjusting the pH to pH 8 with sodium hydroxide. Surfynol™ 465 is a surfactant from Air Products. The resultant inks are the Example Ink and the Comparative Example Ink.

The viscosity of the inks was measured at 25° C. with a TA Rheometer (AR1000N). The flow procedure and a steel cone/plate system (diameter 6:cm; angle: 2°) were used. The viscosity of the inks at a shear rate of 113.7 s⁻¹ is shown in the Table below.

| Ink | Viscosity cP |
|---|---|
| Comparative Example Ink | 9.6 |
| Example Ink | 2.6 |

### Example 3

### Ink-Wet Printing

The Example Ink and the Comparative Ink, prepared as described above, were then filtered through a 0.45 micron nylon filter and incorporated into empty print cartridges using a syringe. These inks were printed using an ink-jet printer. It was found that while the Example Ink fired readily through the print head of the printer the Comparative Ink, due to its increased viscosity, did not.

### Further Inks

The inks described in Tables A and B may be prepared. Numbers quoted refer to the number of parts of the relevant ingredient and all parts are by weight. The inks may be applied to paper by printing.

The following abbreviations are used in Tables A and B:

PG=propylene glycol

DEG=diethylene glycol

NMP=N-methylpyrrolidone

DMK=dimethylketone

IPA=isopropanol

MeOH=methanol

2P=2-pyrrolidone

MIBK=methylisobutyl ketone

P12=propane-1,2-diol

BDL=butane-2,3-diol

CET=cetyl ammonium bromide

PHO=Na₂HPO₄ and

TBT=tertiary butanol

TDG=thiodiglycol

TABLE A

| Dye | | | | | | | Na | | | | |
|---|---|---|---|---|---|---|---|---|---|---|---|
| Content | Water | PG | DEG | NMP | DMK | NaOH | Stearate | IPA | MEOH | 2P | MIBK |
| 2.0 | 80 | 5 | | 6 | 4 | | | | | 5 | |
| 3.0 | 90 | | 5 | 5 | | 0.2 | | | | | |
| 10.0 | 85 | 3 | | 3 | 3 | | | | 5 | 1 | |
| 2.1 | 91 | | 8 | | | | | | | | 1 |
| 3.1 | 86 | 5 | | | | | 0.2 | 4 | | | 5 |
| 1.1 | 81 | | | 9 | | 0.5 | 0.5 | | | 9 | |
| 2.5 | 60 | 4 | 15 | 3 | 3 | | | 6 | 10 | 5 | 4 |
| 5 | 65 | | 20 | | | | | 10 | | | |
| 2.4 | 75 | 5 | 4 | | 5 | | | | 6 | | 5 |
| 4.1 | 80 | 3 | 5 | 2 | 10 | | 0.3 | | | | |
| 3.2 | 65 | | 5 | 4 | 6 | | | 5 | 4 | 6 | 5 |
| 5.1 | 96 | | | | | | | | 4 | | |
| 10.8 | 90 | 5 | | | | | | 5 | | | |
| 10.0 | 80 | 2 | 6 | 2 | 5 | | | 1 | | 4 | |
| 1.8 | 80 | | 5 | | | | | | | 15 | |
| 2.6 | 84 | | | 11 | | | | | | 5 | |
| 3.3 | 80 | 2 | | | 10 | | | | 2 | | 6 |
| 12.0 | 90 | | | | 7 | 0.3 | | 3 | | | |
| 5.4 | 69 | 2 | 20 | 2 | 1 | | | | | 3 | 3 |
| 6.0 | 91 | | | 4 | | | | | | 5 | |

TABLE B

| Dye | | | | | | | | | | | |
|---|---|---|---|---|---|---|---|---|---|---|---|
| Content | Water | PG | DEG | NMP | CET | TBT | TDG | BDL | PHO | 2P | PI2 |
| 3.0 | 80 | 15 | | | 0.2 | | | | | 5 | |
| 9.0 | 90 | | 5 | | | | | | 1.2 | | 5 |
| 1.5 | 85 | 5 | 5 | | 0.15 | 5.0 | 0.2 | | | | |
| 2.5 | 90 | | 6 | 4 | | | | | 0.12 | | |
| 3.1 | 82 | 4 | 8 | | 0.3 | | | | | | 6 |
| 0.9 | 85 | | 10 | | | | | 5 | 0.2 | | |
| 8.0 | 90 | | 5 | 5 | | | 0.3 | | | | |
| 4.0 | 70 | | 10 | 4 | | | | 1 | | 4 | 11 |
| 2.2 | 75 | 4 | 10 | 3 | | | | 2 | | 6 | |
| 10.0 | 91 | | | 6 | | | | | | 3 | |
| 9.0 | 76 | | 9 | 7 | | 3.0 | | | 0.95 | 5 | |
| 5.0 | 78 | 5 | 11 | | | | | | | 6 | |
| 5.4 | 86 | | | 7 | | | | | | 7 | |
| 2.1 | 70 | 5 | 5 | 5 | 0.1 | 0.2 | 0.1 | 5 | 0.1 | 5 | |
| 2.0 | 90 | | 10 | | | | | | | | |
| 2 | 88 | | | | | | 10 | | | | |
| 5 | 78 | | | 5 | | | 12 | | | 5 | |
| 8 | 70 | 2 | | 8 | | | 15 | | | 5 | |
| 10 | 80 | | | | | | 8 | | | 12 | |
| 10 | 80 | | 10 | | | | | | | | |

1. A composition comprising:
a) a dye component comprising a major dye component which is the gluconic acid salt of a mixture of phthalocyanine dyes of Formula (1): 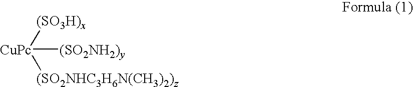
wherein:
Pc represents a phthalocyanine nucleus of formula; 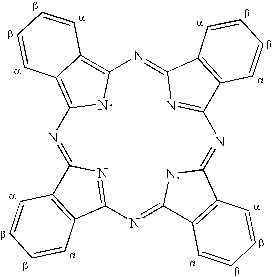
x is 0 to 3.9;
y is 0 to 3.9;
z is 0.1 to 4.0;
the sum of (x+y+z) is 4; and
the substituents, represented by x, y and z are attached to a □ position on the phthalocyanine ring; and
(b) a liquid medium.

2. A composition according to claim 1 wherein x is greater than 0.5.

3. A composition according to claim 1 wherein y is 0.

4. A composition according to claim 1 wherein y is greater than 0.5.

5. A composition according to claim 1 wherein z is greater than 2.

6. A composition according to claim 1 wherein the compound of Formula (1) is of Formula (2) and salts thereof: 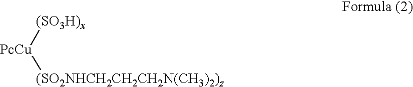
wherein:
Pc represents a phthalocyanine nucleus of formula; 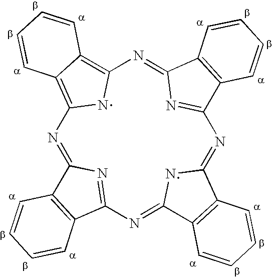
x is 0 to 3.9;
z is 0.1 to 4;
the sum of (x+z) is 4; and
the substituents, represented by x and z are attached to a □ position on the phthalocyanine ring.

7. A composition according to claim 1 wherein the liquid medium (b) comprises water and organic solvent or organic solvent free from water.

8. A composition according to claim 1 which is ink suitable for use in an ink-jet printer.

9. A process for forming an image on a substrate comprising applying ink according to claim 8 thereto by means of an ink-jet printer.

10. A material printed with a composition according to claim 1 or by means of a process according to claim 9.

11. A printed material according to claim 10 which is a photographic reproduction.

12. An ink-jet printer cartridge comprising a chamber and an ink wherein the ink is in the chamber and the ink is as defined in claim 8.

13. A gluconic acid salt of a compound of Formula (1) 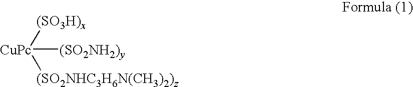
wherein:
Pc represents a phthalocyanine nucleus of formula; 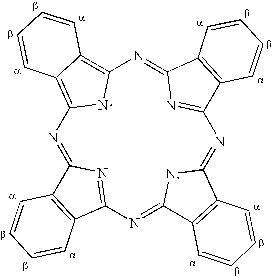
x is 0 to 3.9;
y is 0 to 3.9;
z is 0.1 to 4.0; and
the sum of (x+y+z) is 4.
